(19) United States
(12) Patent Application Publication
(10) Pub. No.: US 2006/0100871 A1
(43) Pub. Date: May 11, 2006

(54) Speech recognition method, apparatus and navigation system

(75) Inventors: In-jeong Choi, Hwaseong-si (KR); Jeong-su Kim, Yongin-si (KR); Kwang-il Hwang, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/253,641

(22) Filed: Oct. 20, 2005

(30) Foreign Application Priority Data
Oct. 27, 2004 (KR) 2004-86228

(51) Int. Cl. G10L 15/04

(52) U.S. Cl. 704/254

(57) ABSTRACT

A speech recognition method and apparatus and a navigation system having the speech recognition apparatus are provided. The speech recognition method includes capturing speech as speech signal and extracting features from the speech signal, selecting candidates of a subword among subwords of the word based on the extracted features and displaying the candidate subwords for the subword, selecting candidates of a next subword following the subword based on the selected candidates of the subword and displaying the candidates of the next subword, and determining whether the user has selected one of the candidates of the next subword and, if not, selecting candidates of subwords following the next subword based on the series of subwords that have been previously selected by the user and displaying the selected candidates of the next subword.

### CROSS-REFERENCE TO RELATED APPLICATION

This application claims the benefit of Korean Patent Application No. 10-2004-0086228 filed on Oct. 27, 2004 in the Korean Intellectual Property Office, the disclosure of which is incorporated herein by reference in its entirety.

### BACKGROUND OF THE INVENTION

1. Field of the Invention

The present invention relates generally to speech recognition. More particularly, embodiments of the present invention relate to speech recognition that supports a multi-modal interface.

2. Description of the Related Art

People's ever-increasing desire for a more convenient life has enabled remarkable development in a wide variety of technical fields. Speech recognition is one such technical fields. Speech recognition has long been researched, and in recent years, has been applied to a variety of digital devices. Good examples in the field of automatic speech recognition include mobile phones, in which speech recognition may be implemented as voice calling technique, allowing users to make a call using their voice.

In more recent years, there have been remarkable increases in the number of applications of telematics systems. As a cross between a communications system and a computer system, a telematics system may be embodied in a vehicle as a computer, a wireless connection to either an operator or data services such as the Internet, and a Global Position System (GPS). An in-car telematics system supports many kinds of real-time information such as a car accident information, driving route information, traffic information and so on, for a driver and passengers. For example, in the event of a vehicle breakdown occurring while driving, the in-vehicle telematics service enables a driver to transmit information about the vehicle breakdown to a roadside service center via wireless communication. The in-vehicle telematics service may also enable a driver to receive e-mail and to view a route guide through a computer monitor installed at a console provided in front of the driver's seat.

In order to integrate a voice-activated routing service in a telematics system, which allows drivers to speak a city name or address presented in the database of the telematics system and receive turn-by-turn voice guidance to destinations, the telematics system should include thousands of geographic names despite limited computing power and memory resources. However, unfortunately, these limitations keep speech recognition systems in mobile phones from handling several thousand words with a conventional static or dynamic search network. Thus, there is a need for a method of effectively reducing a valid word set for speech recognition.

A spelling-based speech recognition method, which allows speakers to utter words letter-by-letter, needs limited resources, relatively. U.S. Pat. Nos. 6,629,071 and 5,995,928 disclose voice recognition systems adopting conventional spelling-based speech recognition methods. A spelling-based speech recognition method, however, is not suitable for recognizing long vocabularies. In addition, a spelling-based speech recognition method may not be suitable for some languages such as the Korean language known as a Hangul which includes Jamos or syllables. Each Hangul has three Jamos, a leading consonant (Choseong), a medial vowel (Jungseong), and a trailing consonant (Jongseong). A Hangul need not have a leading consonant, or a trailing consonant, which means that it is quite difficult to differentiate the leading consonant and the trailing consonant from each other. For example, the Korean words or phrases “ [symbol] (deul-eo)” having a trailing consonant in its first character and “ [symbol] (deu-reo)” having a leading consonant in its second character are quite difficult to distinguish from each other when spelt out.

Therefore, there is a need for a natural-language speech recognition method. Examples of existing natural-language speech recognition that supports a multi-modal interface are disclosed in U.S. Pat. Nos. 6,438,523 and 6,694,295.

FIG. 1 is a block diagram of a conventional speech recognition apparatus disclosed in U.S. Pat. No. 6,438,523, entitled “Processing Handwritten and Hand-Drawn Input and Speech Input.”

Referring to FIG. 1, the computer system includes a mode controller 102, a mode processing logic 104, an interface controller 106, a voice interface 108, a pen interface 110, and a plurality of application programs 116.

The interface controller 106 controls the voice interface 108 and the pen interface 110, and provides a pen input or a voice input to the mode controller 102. The voice interface 108 codes an electrical signal generated by a microphone 112 into a digital stream that can be processed by the mode processing logic 104. Likewise, the pen interface 110 processes a hand-drawn input generated using a pen 114.

The mode controller 102 sets an operating state for the computer system by activating the mode processing logic 104 according to the information input thereto from the interface controller 106. In the operating state, the computer system can manage the processing of the information input from the interface controller 106, and the transmitting of the processed information to the application programs 116. The application programs 116 include various programs for forming, editing, and viewing electronic documents, such as word processing programs, graphic design programs, spreadsheet programs, email programs, and web browsing programs.

The computer system shown in FIG. 1 enables a user to conveniently write or edit a document using the both a voice input and a pen input. However, the computer system shown in FIG. 1 needs additional resources for recognizing a text message input by the user, and is difficult to control especially when users attempt both a voice input and a pen input at the same time.

The speech recognition method disclosed in U.S. Pat. No. 6,694,295 can increase the performance of speech recognition accuracy by recognizing letters input using a keyboard or a touch screen and recognizing only words beginning with the letters as the words in question. However, this approach can also cause inconvenience in that users are requested to press specific buttons or use a keyboard. In addition, the recognition apparatus must have a function to search the considerable amount of words in question. Therefore, there is a need for a new speech recognition method that enables a large vocabulary search to be carried out with relatively limited resources.

### SUMMARY OF THE INVENTION

An aspect of the present invention provides a speech recognition method and apparatus that supports a multi-modal interface suitable for searching a large vocabulary search network.

An aspect of the present invention also provides a telematics device using a speech recognition apparatus supported by a multi-modal interface suitable for a large vocabulary search.

Additional aspects and/or advantages of the invention will be set forth in part in the description which follows and, in part, will be apparent from the description, or may be learned by practice of the invention.

According to an aspect of the present invention, there is provided a speech recognition method in which a word is recognized from a user's natural utterance, the speech recognition method including capturing speech as a speech signal and extracting features from the speech signal, selecting candidates of a subword among subwords of the word based on the extracted features and displaying the candidate subwords for the subword, selecting candidates of a next subword following the subword based on the selected candidates of the subword and displaying the candidates of the next subword, and determining whether the user has selected one of the candidates of the next subword and, if not, selecting candidates of subwords following the next subword based on the series of subwords that have been previously selected by the user and displaying the selected candidates of the next subword.

According to another aspect of the present invention, there is provided a speech recognition apparatus that recognizes a word from a user's natural utterance, the speech recognition apparatus including a microphone to convert the user's speech into an electrical signal, a feature extraction module to extract features from the electrically converted speech signal, a subword decoder to divide the word into a plurality of subwords based on the extracted features and select subword candidates for each of the subwords of the word, a display module to display the subword candidates for each of the subwords of the word, an input module to allow the user to select one of the subword candidates for each of the subwords of the word, and a determination module to determine one of candidate words that matches the word based on a subword candidate or a series of subword candidates that have been selected by the user using the input module.

According to still another aspect of the present invention, there is provided a navigation system including a display device, a speech recognition apparatus to capture a speech as speech signal from a user's natural utterance, extract features from the speech signal, divide a word or word series corresponding to the speech signal into a plurality of subwords, select subword candidates for each of the subwords of the word, and recognize the name of a place designated by the word based on a subword or subword series selected by the user among the subword candidates, a map database to store maps of different places, and a navigation controller to fetch a map corresponding to the recognized place name received from the speech recognition apparatus from the map database and transmit the fetched map to the display device.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional speech recognition apparatus;

FIG. 2 is a block diagram of a speech recognition system according to an exemplary embodiment of the present invention;

FIG. 3 is a block diagram of a multi-modal vocabulary search device according to an exemplary embodiment of the present invention;

FIG. 4 is a flowchart of a speech recognition method according to an exemplary embodiment of the present invention;

FIG. 5 is a schematic representation of a display screen according to an exemplary embodiment of the present invention;

FIG. 6 is a schematic representation of a speech recognition method according to an exemplary embodiment of the present invention;

FIG. 7 is a schematic representation of a display screen according to another exemplary embodiment of the present invention;

FIGS. 8 and 9 are schematic representations of lexical structures used in a vocabulary search device according to exemplary embodiments of the present invention;

FIG. 10 is a schematic representation of a constrained search method according to an exemplary embodiment of the present invention; and

FIG. 11 is a block diagram of a navigation system according to an exemplary embodiment of the present invention.

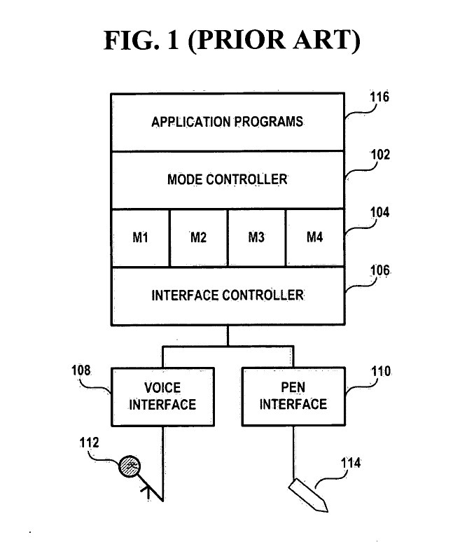

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

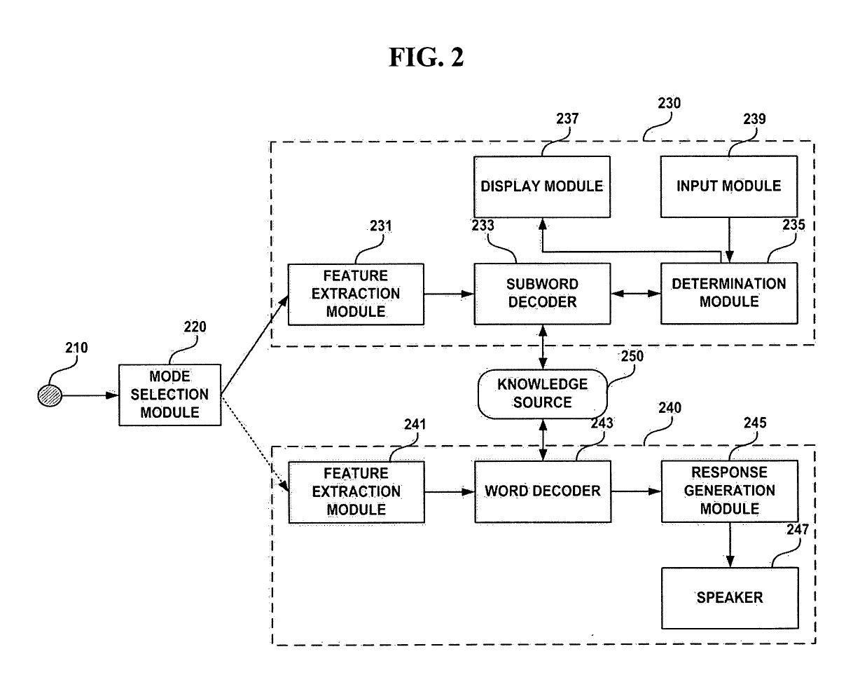

FIG. 2 is a block diagram of a speech recognition system according to an exemplary embodiment of the present invention. Referring to FIG. 2, the speech recognition system may include a microphone 210, a mode selection module 220, a multi-modal vocabulary search device 230, a speech recognition vocabulary search device 240, and a knowledge source 250.

The microphone 210 may convert a user's speech into an electrical signal. The mode selection module 220 may selectively activate one of the multi-modal vocabulary search device 230 and the speech recognition vocabulary search device 240 in response to a user command. For example, if the user selects the multi-modal vocabulary search device 230 to carry out speech recognition, the mode selection module 220 activates the multi-modal vocabulary search device 230 and inactivates the speech recognition vocabulary search device 230. Likewise, if the user selects the speech recognition vocabulary search device 230 to carry out speech recognition, the mode selection module 220 activates the speech recognition vocabulary search device 240 and inactivates the multi-modal vocabulary search device 230. Alternatively, the speech recognition system itself may select a speech recognition mode based on the circumstances. For example, in the case of providing a telematics service to a vehicle, the speech recognition system may select the multi-modal vocabulary search device 230 to carry out speech recognition when the vehicle is at a standstill and may select the speech recognition vocabulary search device 240 to carry out speech recognition when the vehicle is traveling.

The multi-modal vocabulary search device 230 may include a feature extraction module 231, a subword decoder 233, a determination module 235, a display module 237, and an input module 239.

The feature extraction module 231 may extract features of an input speech signal. Feature extraction is to take out various components useful for speech recognition from the input speech signal and is generally associated with compression and dimensional reduction of data. The features extracted from the input speech signal may be transmitted to the subword decoder 233. There has been no ideal method of extracting features from speech signal available yet in the field of feature extraction, and intensive research into speech recognition has been undertaken, specializing in extraction of various features that are perceptually meaningful and robust to noisy environment/speaker/channel variations while successfully reflecting temporal variations. Examples of features used in speech recognition include linear predictive coding (LPC) cepstrum, perceptual linear prediction (PLP) cepstrum, Mel frequency ceptral coefficients (MFCCs), differential cepstrum, filter bank energy, and differential energy.

The multi-modal vocabulary search device 230 may include a front-end detection module (not shown), which may detect the beginning point and the end point of speech signal. Thus, the feature extraction module 231 may extract features from a speech signal whose beginning and end points are detected by the front-end detection module. The front-end detection module may be designed to detect on its own the beginning point and the end point of speech signal input thereto. Alternatively, the front-end detection module may be implemented such that it receives a voice input only while a predetermined button is being pressed by a user.

The subword decoder 233 may determine subword candidates to be recognized next based on series of subwords that have been recognized. Here, subwords are speech recognition units that constitute a word, which corresponds to the input speech signal. For example, if the word to be recognized is a Korean language, syllables may be considered as the subwords. For example, a Korean word ‘seo ul yuk (Seoul Station)’ consists of three subwords ‘seo’, ‘ul’ and ‘yuk’. If the word to be recognized is a Japanese language, Hiragana or Kanji (which may be composed of 2 or more syllables) may be considered as the subwords. If the word to be recognized is a Chinese language, Chinese-derived Kanji may be considered as the subwords.

The determination module 235 determines a word based on the series of subwords that have been recognized. The word is determined by the user using the input module 239. The input module 239, which may be used by the user to determine the match for the word to be recognized based on the recognized subword(s), may be realized as a keypad or a touch pen. The display module 237 displays either the recognized subword(s) or the determined word. In a case where the input module 239 is realized as a touch screen, the display module 237 may also perform some of the functions of the input module 239.

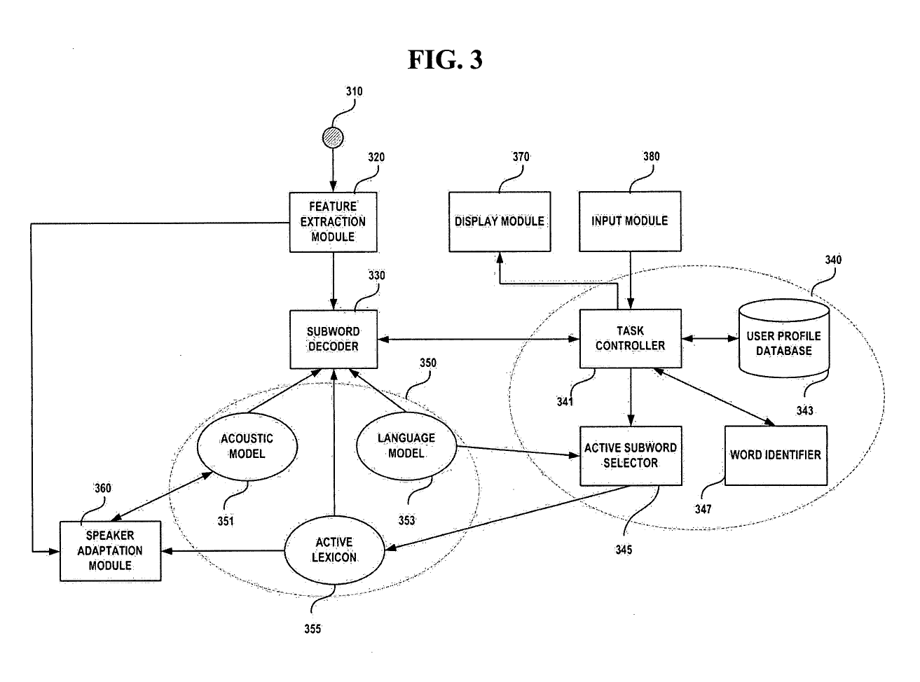

The functions and operation of the multi-modal vocabulary search device 230 will be described later in detail with reference to FIG. 3.

The speech recognition vocabulary search device 240 may include a feature extraction module 241, a word decoder 243, a response generation module 245, and a speaker 247.

The feature extraction module 241 performs the same functions as the feature extraction module 231 of the multi-modal vocabulary search device 230, and thus, the feature extraction modules 241 and 231 can be integrated into a single module.

The word decoder 243 may recognize a word corresponding to the input speech signal based on features extracted from the input speech signal by the feature extraction module 241. The response generation module 245 may generate a response message based on the recognition results provided by the word decoder 243 and output the generated response message via the speaker 247.

For example, if the speech recognition vocabulary search device 240 is applied to a telematics device for providing geographical information and the user desires to know about the location of Seoul Station, the response generation module 245 outputs a message ‘Please tell me the name of a city or a province you wish to search for.’ via the speaker 247, and the user utters a word ‘seo ul (Seoul)’. Then, the word decoder 243 recognizes the word ‘seo ul’ spoken by the user and transmits the recognition results to the response generation module 245. Then, the response generation module 245 attempts to confirm the recognition results provided by the word decoder 243 by outputting a message ‘Is it ‘seo ul’ that you are searching for?’ via the speaker 247. If the user utters “Yes”, the word decoder 243 notifies the response generation module 245 that the user answered ‘yes’. Thereafter, the response generation module 245 outputs a message “What area in ‘seo ul’ do you wish to search for?” via the speaker 247. If the user utters a series of words ‘yong san gu’, the response generation module 245 outputs a message “Is it ‘yong san gu’ that you are searching for?” via the speaker 247. If the user utters “Yes”, the word decoder 243 notifies the response generation module 245 that the user answered yes. Then, the response generation module 245 outputs a message “Please tell me the name of a place in ‘yong san gu’ you wish to search for.” via the speaker 247. If the user utters a word ‘seo ul yuk (Seoul Station)’, the word decoder 243 recognizes that the place the user wishes to search for is Seoul Station. In the question-and-answer manner, the user can obtain information regarding the location of the place that he or she wishes to search for using the speech recognition vocabulary search device 240.

The knowledge source 250 may help the subword decoder 233 or the word decoder 243 recognize the word.

FIG. 3 is a block diagram of a multi-modal vocabulary search device according to an exemplary embodiment of the present invention. Referring to FIG. 3, the multi-modal vocabulary search device may include a microphone 310, a feature extraction module 320, a subword decoder 330, a knowledge source 350, a determination module 340, a speaker adaptation module 360, a display module 370, and an input module 380.

The feature extraction module 320 may receive a speech signal from the microphone 310, extract features from the received speech signal, and transmit the extracted features to the subword decoder 330.

The subword decoder 330 may receive the features of the speech signal from the feature extraction module 320 and recognize the same in units of subwords. The basic principle of recognizing the speech signal in units of subwords will now be described in further detail. In general, since a word may be composed of one or more subwords, it is possible to considerably reduce the size of a word set that needs to be searched in a multi-modal vocabulary search by recognizing a word or a series of words spoken by a user in units of subwords. In other words, if a subword of the received speech signal is recognized, the recognized subword may be identified using the input module 380. Then, searching for a match for the word spoken by the user is carried out using a set of candidate words containing the identified subword, instead of using an entire candidate word set. For example, if the received speech signal corresponds to the word ‘seo ul yuk (Seoul Station)’ and the subword ‘seo’ of the word ‘seo ul yuk’ has been recognized, word sets containing the subword ‘seo’ are set as the word set that needs to be searched. If a subword ‘ul’ of the received speech signal is further recognized, the word set that needs to be searched is much further reduced to a set of words containing both of the subwords ‘seo’ and ‘ul’.

In selecting words in units of subwords for speech recognition, it is preferable that none of the subwords of the received speech signal are silence or have more than one pronunciation and that the received speech signal does not have too many subwords. However, Asian languages generally have these features so that they are advantageously subjected to speech recognition based on words selected in units of subwords. The Korean language, in particular, has only about 2,000 units of recognizable subwords (syllables). Thus, there are not many words that need to be searched for at any stage of a vocabulary search.

In the present embodiment, no restriction is imposed on the user's way of speaking in order to recognize the received speech signal in units of the subwords step by step. In other words, when the user utters in a natural way, speech recognition can be performed according to embodiments of the present invention.

The determination module 340 may include a task controller 341, a user profile database 343, an active subword selector 345, and a word identifier 347. The task controller 341 may manage the active subword selector 345, the word identifier 346, the display module 370, and the input module 380.

Based on the series of subwords of the received speech signal having been recognized, the active subword selector 345 may determine what subwords of the received speech signal are to be recognized next. For example, if the subword ‘seo’ of the word ‘seo ul yuk’ has been recognized, the active subword selector 345 may determine the subword ‘ul’ following the subword ‘seo’ to be recognized next.

The word identification module 347 may search for a plurality of candidate words containing the subword(s) of the received speech signal that have been recognized. For example, if the subwords ‘seo’ and ‘ul’ of the word ‘seo ul yuk’ have been recognized, the word identification module 347 identifies several candidate words beginning with ‘seo ul’ as search results, such as ‘seo ul’, ‘seo ul ga yang cho deung hak kyo (Seoul Kayang Elementary School)’, ‘seo ul kang nam cho deung hak kyo (Seoul Kangnam Elementary School)’, and so on. Then, the display module 370 displays the candidate words provided by the word identification module 347 and the subword(s) of the received speech signal that have been received. The user may select one of the candidate words displayed by the display module 370 in the middle of speech recognition using the input module 380. For example, if the subwords ‘seo’ and ‘ul’ of the word ‘seo ul yuk’ have been recognized, the user may determine the candidate word ‘seo ul kang nam cho deung hak kyo’.

The user profile database 343 may store words that have been searched for by the user. Particularly, in a case where the multi-modal vocabulary search device is applied to a telematics device, it is possible for the user to easily retrieve the name of a place that has already been searched for from the multi-modal vocabulary search device by storing the name of the place in the user profile database 343.

The knowledge source 350 includes an acoustic model 351, a language model 353, and an active lexicon 355.

The acoustic model 351 is used to recognize the user's voice. In general, acoustic models used in the field of speech recognition are based on a Hidden Markov model (HMM). Speech recognition units used in an acoustic model include phonemes, diphones, triphones, quinphones, syllables, and words. In the present embodiment, speech recognition is carried out in units of subwords. If the Korean language is a language to be recognized, the acoustic model 351 may be established so that speech recognition may be carried out in units of syllables. In the present embodiment, however, speech recognition units other than syllables, for example, diphones, triphones, or quinphones, may also be used to carry out speech recognition in consideration of coarticulation across syllables in natural speech. The acoustic model 351 may be specialized by user through the speaker adaptation module 360. In this case, the user may be trained using the acoustic model 351.

The language model 351 may support grammar. The language model 351 is generally used in continuous speech recognition. The use of the language model 351 can reduce the size of a search space of the speech recognition apparatus. In addition, the language model 351 increases a probability of grammatically correct sentences, thereby enhancing speech recognition rates. Examples of the grammar supported by the language model 351 include grammars for a formal language, such as a finite state network (FSN) and a context-free grammar (CFG), and statistical grammars, such as an n-gram model. Here, an n-gram model is a grammar that defines the probability of words to appear next using the preceding (n−1) words. Examples of the n-gram model include a bigram model, a trigram model, and a tetragram model. A syllable may be pronounced differently when it is isolated rather than when it is together with other syllables due to phonetic mutation or coarticulation. Thus, in the present embodiment, different pronunciations of a syllable may be treated as if they were different syllables, and then, the fact that the different pronunciations originate from the same syllable may be specified using the grammar provided by the language model 351. For example, if the user continuously utters a sentence ‘Search for Seoul Station’ in Korean, it may be pronounced as ‘seo ul ryo guel cha ja jwo’ or ‘seo ul yu guel cha ja jwo’.

The active lexicon 353 is a phonetic model for modeling pronunciations as recognition units, i.e., subwords. There are a wide variety of phonetic models, including a simple phonetic model providing only a single canonical pronunciation for each subword based on a standard pronunciation dictionary, a multiple phonetic model providing a plurality of pronunciation entries for a recognition vocabulary dictionary, which reflects a range of pronunciations and accents for each subword and dialect, a statistical phonetic model in which the probabilities of different pronunciations of each subword are taken into consideration, and a phoneme-based lexical phonetic model. In the present embodiment, a phoneme-based pronunciation dictionary may be formed based on a lexical phonetic model and then extended to a triphone-based pronunciation dictionary.

The term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

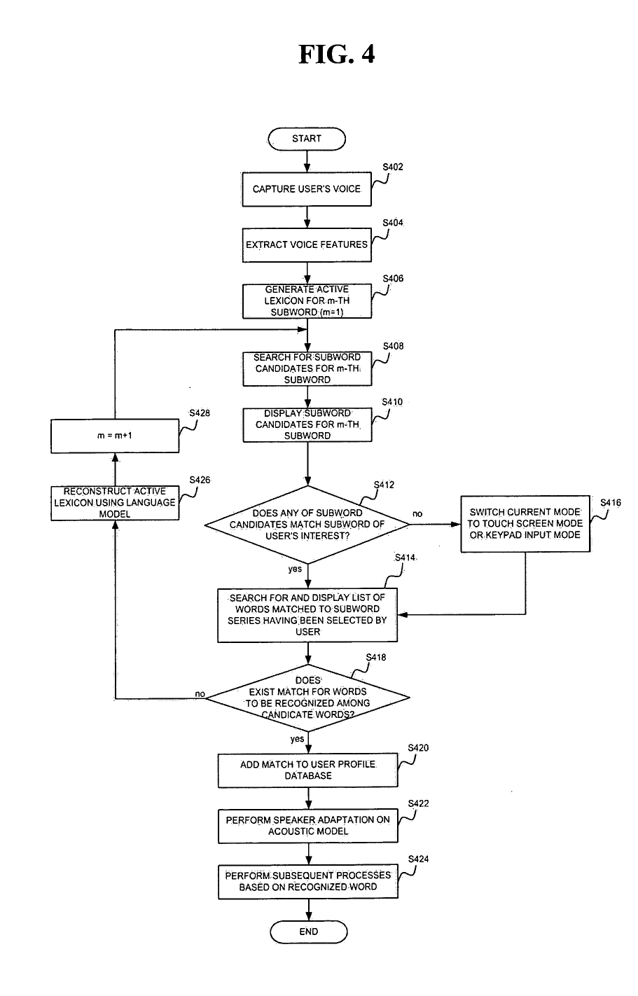

A multi-modal speech recognition method will now be described in detail. FIG. 4 is a flowchart of a speech recognition method according to an exemplary embodiment of the present invention. Referring to FIG. 4, in operation S402, a voice is detected from a user's natural utterance. In an embodiment of the present invention, a voice portion is captured by detecting the beginning point and the end point of the voice detected from the user's natural utterance. The voice is converted into an electrical signal via a microphone.

In operation S404, features are extracted from the speech signal. In operation S406, an active lexicon is created for an m-th subword (e.g., m=1) of a word to be recognized corresponding to the speech signal is created. In operation S408, subword candidates which could be determined to match the m-th subword are searched for. In operation S410, the subword candidates are displayed. In operation S412, it is determined whether any of the subword candidates matches the m-th subword. Assuming that the user is highly likely to determine a subword candidate without delay after finding out a subword candidate that is a match for the m-th subword, it is determined that none of the subword candidates match the m-th subword if the user does not select any of the subword candidates within a predetermined period of time or if the user selects an item ‘No match’ displayed by a speech recognition apparatus to indicate that none of the subword candidates matches the m-th subword.

In operation S416, if none of the subword candidates are determined to match the m-th subword, a current display mode is switched to a touch screen mode or a keypad input mode. Thus, the user can enter a subword or a series of subwords using an input module, such as a touch screen or a keypad.

When the subword is determined, in operation S414, a list of words matched to the subword series having been selected are searched for and displayed. In operation S418, it is determined whether one among the words displayed in operation S414 is selected or not. If so, the selected word to be recognized is added to a user profile database in operation S420. In operation S422, a speaker adaptation operation is carried out on an acoustic model based on the user's utterance and a result of carrying out speech recognition on the user's utterance. In operation S424, subsequent processes are carried out on the words to be recognized. For example, if the speech recognition apparatus is applied to telematics device, a map of a place designated by the words to be recognized may be displayed or various devices connected to the speech recognition apparatus may be controlled.

If none of the candidate words provided in operation S414 are determined to match the words to be recognized, the active lexicon is reconstructed using a language model in operation S426. In operation S428, 1 is added to m, and the speech recognition method returns to operation S408. Thus, another iteration of the speech recognition method is carried out for an (m+1)-th subword (e.g., a second subword) of the words to be recognized corresponding to the speech signal.

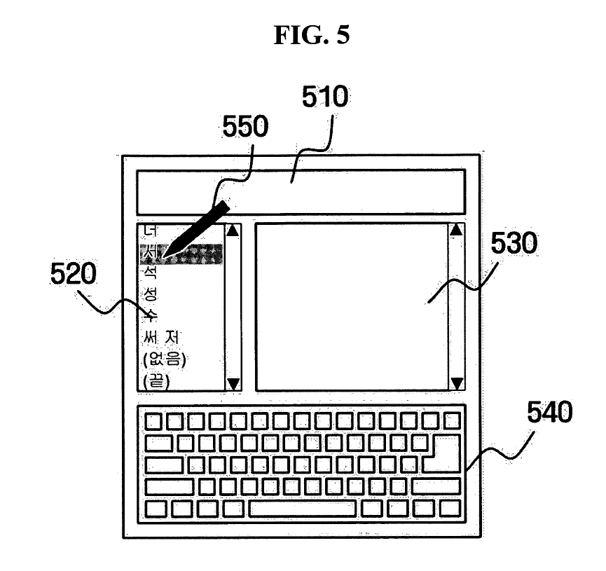

FIG. 5 is a schematic representation of a display screen according to an exemplary embodiment of the present invention. Referring to FIG. 5, the display screen may include a partial recognition result window 510, a subword recognition result window 520, and a searched candidate subword window 530, which may display a series of subwords that have been recognized.

The subword recognition result window 520 may display subword candidates that could be determined to match a subword currently being searched for. A user may select one of the subword candidates using an input module, such as a touch pen 550.

The searched candidate subword window 530 displays a list of subword candidates containing the subword or series of subwords that have been recognized. The user may select one of the candidates displayed in the searched candidate subword window 530 in the middle of speech recognition using, for example, the touch pen 550.

A letter input module 540 may be used by the user to enter a subword or a series of subwords of his or her interest when none of the subword candidates match the subword(s) of his or her interest. The letter input module 540 may be implemented as a touch screen or a keypad separate from a display module.

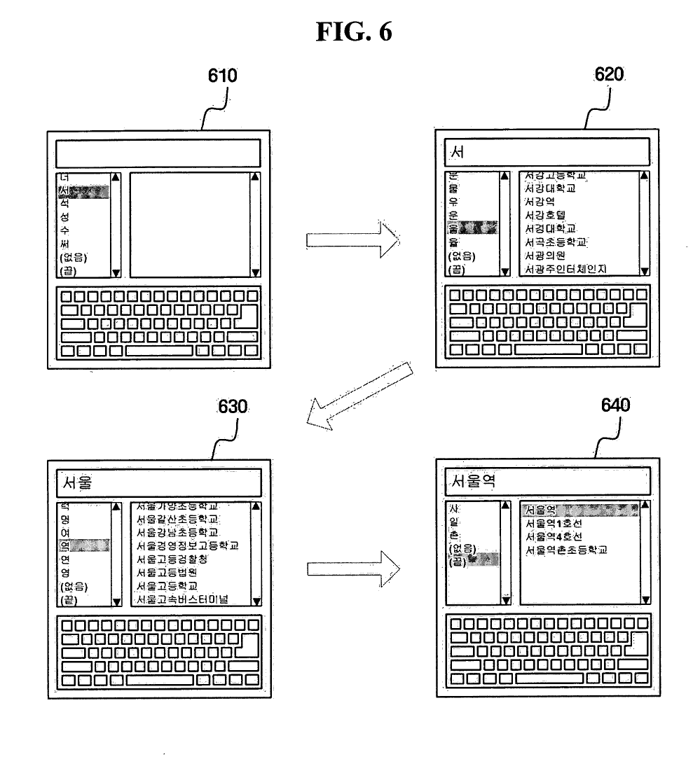

FIG. 6 is a schematic representation of a speech recognition method according to an exemplary embodiment of the present invention. Referring to FIG. 6, if a user utters a sentence “Please, search for ‘seo ul yuk’”, a speech recognition apparatus recognizes that the user desires to search for the name of a place designated by the to-be-recognized-word ‘seo ul yuk’. In operation 610, the speech recognition apparatus displays a list of first subword candidates that could be a match for a subword of the to-be-recognized-word ‘seo ul yuk’, e.g., ‘seo’, in a subword recognition result window

In operation S620, if the user selects one of the first subword candidates displayed in the subword recognition result window, for example, ‘seo’, using an input module, such as a touch pen, the speech recognition apparatus displays a plurality of second subword candidates that could be a match for another subword of the to-be-recognized-word ‘seo ul yuk’, e.g., ‘ul’, in the subword recognition result window and displays a list of candidates beginning with ‘seo’ in a searched candidate window so that the user can select one of the displayed candidate words that matches the to-be-recognized-word ‘seo ul yuk’.

In operation S630, if the user selects one of the second subword ‘ul’ using the input module, the speech recognition apparatus displays the selected ‘ul’ and ‘seo ul’ containing the previously selected subword ‘seo’ together with a list of candidates of a next subword that could be a match for the word ‘seo ul’ in the subword recognition result window. Likewise, the speech recognition apparatus displays a list of word series beginning with ‘seo ul’ in the searched candidate subword window so that the user can select one of the candidate words that matches the word ‘seo ul’.

In operation S640, if the user selects a subword ‘yuk’ using the input module, the speech recognition apparatus displays the selected subword ‘yuk’, ‘seo ul yuk’ containing the previously selected subword ‘seo ul’ together with a list of candidates of a next subword that could be a match for the word ‘seo ul yuk’ in the subword recognition result window. Likewise, the speech recognition apparatus displays a list of word series beginning with ‘seo ul yuk’ in the searched candidate subword window so that the user can select one of the candidate words that matches the word ‘seo ul yuk’.

If all of the subwords of the word ‘seo ul yuk’ have been successfully recognized, the user may select an item ‘End of process’ displayed in the subword recognition result window or the word ‘seo ul yuk’ displayed in the searched candidate subword window so that the to-be-recognized-word ‘seo ul yuk’ is recognized.

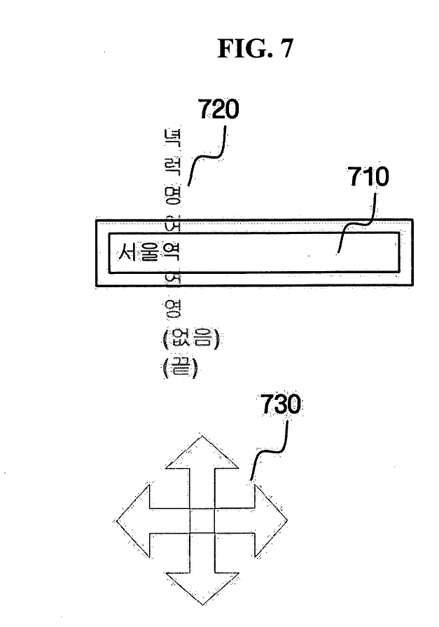

FIG. 7 is a schematic representation of a display screen according to another exemplary embodiment of the present invention. The display screen illustrated in FIG. 5 is suitable for a display module that can provide a sufficiently large screen. However, if the display module cannot provide a sufficiently large screen, the display screen illustrated in FIG. 7 may be more suitable than the display screen illustrated in FIG. 5.

Referring to FIG. 7, the display screen may include a display window 710, on which a subword or a series of subwords that have been recognized and one of a plurality of subword candidates 720 that could be a match for a subword currently being recognized are displayed together. The display screen may not be able to display all of the subword candidates 720 together in the display window 710. Instead, the display screen may display the subword candidates 720 on the display window 710 one-at-a-time according to information input by a user using a direction button 730.

The display screen of FIG. 5 or 7 may display search results on the basis of the following criteria. That is to say, recognition candidates may be displayed in an alphabetical order. However, if there are too many candidates to be displayed, only the candidates beginning with an alphabet or a grapheme entered by a user using the letter input module 540 may be displayed on the display screen shown in FIG. 5 or 7. For example, if the user utters a sentence ‘search for Seoul Station’ in Korean and there are too many candidates for a subword ‘seo’ of a series of words to be recognized ‘seo ul yuk (Seoul Station)’ to be displayed, the user may enter a Korean alphabet corresponding to a first phoneme ( [symbol] ) of the subword ‘seo’, and then a speech recognition apparatus may display only the subword candidates beginning with the entered Korean alphabet ‘ [symbol] ’.

If none of the subword candidates or candidate words displayed on the display screen shown in FIG. 5 or 7 match a subword or word to be recognized, the user may enter one or more letters on the display screen shown in FIG. 5 or 7 using an input module that has already been described above with reference to FIG. 4. In other words, a current recognition mode is switched from a speech recognition mode to a letter recognition mode. Alternatively, all of the search results including the subword candidates or the candidate series of words except for an active lexicon may be refreshed, and then the refreshed results may be displayed.

While the above description has explained that the display screen shown in FIG. 5 or 7 displayed the recognition candidates in the alphabetical order, the display screen shown in FIG. 5 or 7 may display the candidate series of words in consideration of whether they have been registered with a user profile database and the alphabetical order thereamong. Alternatively, in a case where the speech recognition apparatus is applied to telematics device, the display screen shown in FIG. 5 or 7 may display the candidate series of words in the order of increasing distances between a reference location and the locations of places corresponding to the candidate series of words so that a candidate series of words corresponding to a place closer to the reference location is displayed ahead of a candidate series of words corresponding to a place less close to the reference location, or the display screen shown in FIG. 5 or 7 may display the candidate series of words in consideration of both the distances between the reference location and the locations of the places corresponding to the candidate series of words and the moving direction of a vehicle equipped with the telematics device.

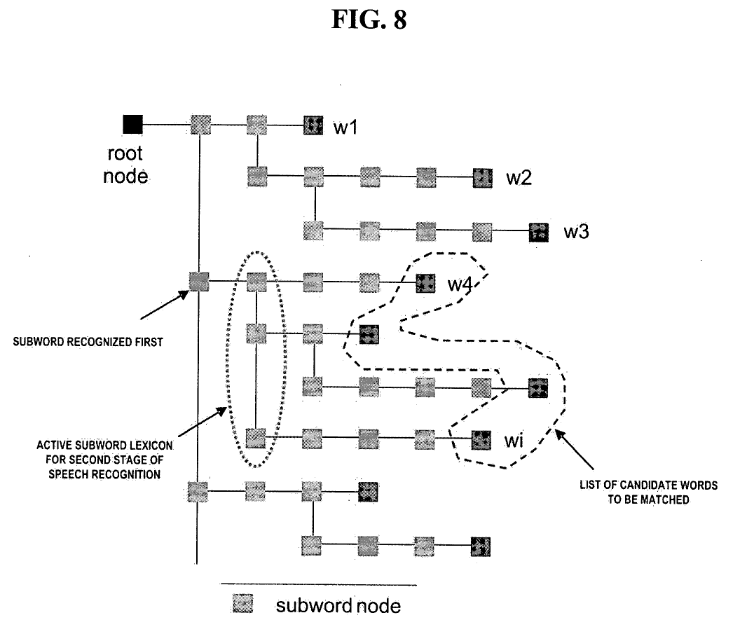

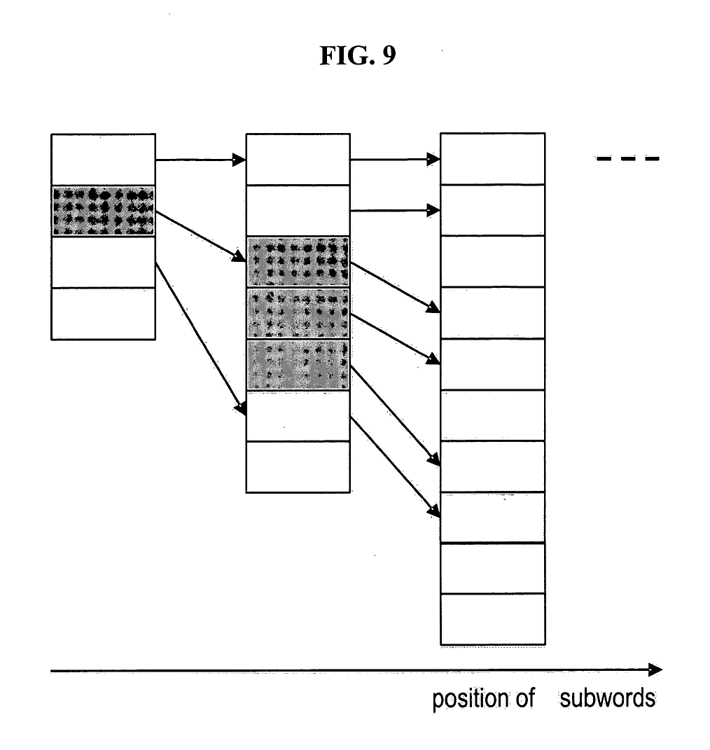

FIGS. 8 and 9 are schematic representations of lexical structures used in a vocabulary search device according to exemplary embodiments of the present invention.

A dictionary used in the vocabulary search device according to an exemplary embodiment of the present invention may have, for example, a tree structure, so that a plurality of candidate series of words containing a subword or a series of subwords that have been recognized can be easily searched for and an active lexicon for a subword following the subword(s) that have been recognized can be easily provided.

In detail, FIG. 8 is a schematic representation of a dictionary having a tree structure. Referring to FIG. 8, when a first subword of the word to be recognized is recognized at the root node of the tree structure, three subword candidates are branched off from the first recognized subword. In a second iteration stage of speech recognition, the number of subword candidates that could be a match for the series of subwords to be recognized is reduced to that of series of subwords enclosed by a dotted line as illustrated in FIG. 8. Once the second subword or series of words t is recognized, the number of subword candidates can be further reduced.

FIG. 9 is a schematic representation of recognizable subwords for each stage of speech recognition. Referring to FIG. 9, if one of a plurality of subword candidates for a first subword of the series of words to be recognized is selected, a plurality of subword candidates for a second subword of the series of words to be recognized are provided. Thereafter, if one of the subword candidates for the second subword of the series of words to be recognized is selected, a plurality of subword candidates for a third subword of the series of words to be recognized may be provided.

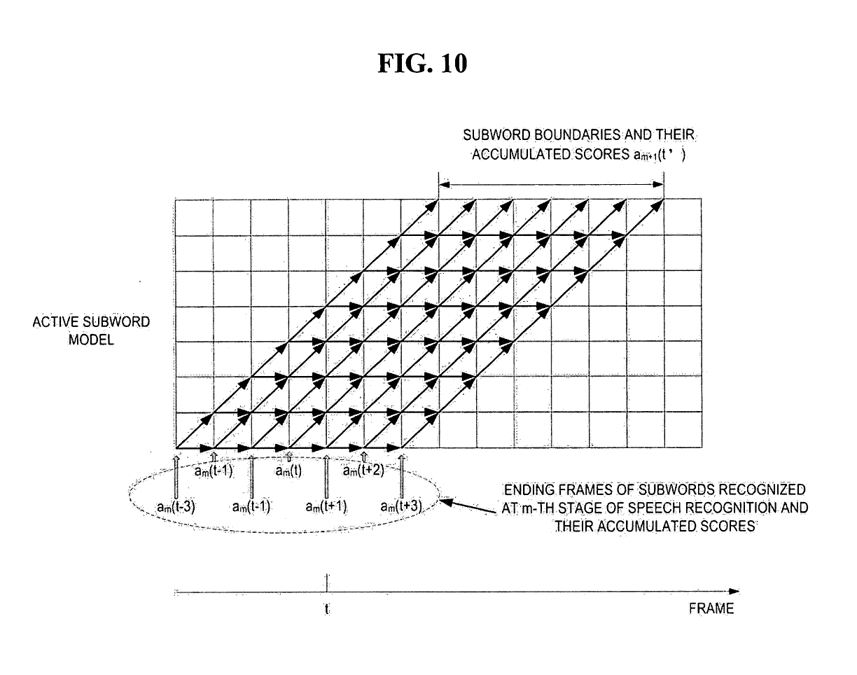

FIG. 10 is a schematic representation of a constrained search method according to the present invention. In embodiments of the present invention, a user's natural utterance can be recognized with less memory using a constrained search method. In other words, since a limited number of candidate subwords are provided at each stage of speech recognition and an active subword lexicon changes for each stage of speech recognition, only a small amount of memory is required by a search network. In addition, since a user selects one of a plurality of candidate subwords as a match for a subword of his or her interest, no computation or memory usage is needed for cross-subword variations.

FIG. 10 illustrates a plurality of search paths for an (m+1)-th stage of speech recognition. Referring to FIG. 10, a recognition engine may obtain information regarding identity of a subword selected at an m-th stage of speech recognition, a range of ending frames of the selected subword, and accumulated scores at each of the ending frames. Here, the information may be obtained using the subword recognition result determined by the user at the m-th stage. Thereafter, a subword search is carried out only on active subword lexicons that can follow the selected candidate subword based on the information obtained by the recognition engine. In the embodiments of the present invention, instead of the continuous speech recognition approach, a multi-stage isolated language recognition approach may be adopted. In addition, a range of speech signal searched for at each stage of speech recognition may be automatically determined and divided. In FIG. 10, aₘ indicates the number of ending frames of subwords recognized at the m-th stage and their accumulated scores.

In the embodiments of the present invention, if the number of candidate series of words that are determined to partially match a word or a series of words to be recognized at the m-th stage does not exceed a predetermined value, for example, 200, a current search mode may be switched from a subword search mode to a vocabulary search mode. In other words, if there are only a small number of candidate words, e.g., 200 candidate words, for the words to be recognized, speech recognition may be carried out on the candidate words in units of words, instead of in units of subwords, by deciding orders of the candidate words based on how much they match the words to be recognized and displaying the candidate words according to their orders.

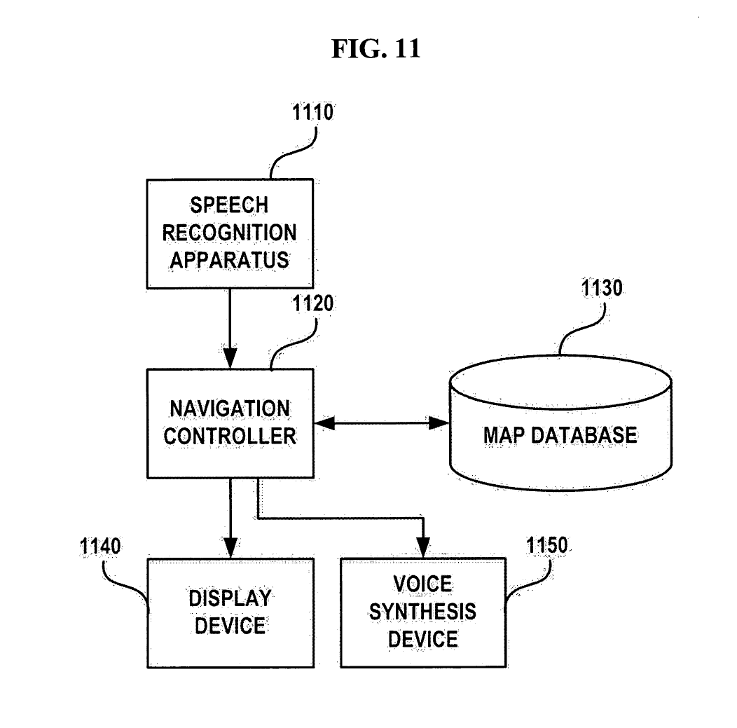

FIG. 11 is a block diagram of a navigation system according to an exemplary embodiment of the present invention. Referring to FIG. 11, the navigation system may include a speech recognition apparatus 1110, a navigation controller 1120, a map database 1130, a display device 1140, and a voice synthesis device 1150.

The speech recognition apparatus 1110 may recognize a word or words naturally uttered by a user. The speech recognition apparatus 1110 may include the multi-modal vocabulary search device 230 shown in FIG. 2 and may also include the speech recognition vocabulary search device 240 shown in FIG. 2.

The navigation controller 1120 may fetch a map corresponding to the words recognized by the speech recognition apparatus 1110 from the map database 1130 and display the fetched map using the display device 1140. Multi-modal speech recognition may not be achieved during driving. In such a case, the name of a place can be searched for in a question-and-answer manner using the voice synthesis device 1150.

In the present embodiment, the speech recognition apparatus 1110 is applied to the navigation system but can be applied to other devices, such as a personal digital assistant (PDA) or a mobile phone. Therefore, those skilled in the art will appreciate that the disclosed preferred embodiments of the invention are used in a generic and descriptive sense only and not for purposes of limitation and that many variations and modifications can be made to the preferred embodiments without substantially departing from the principles of the present invention. The present invention could be embodied using a storage for controlling a computer, such as a machine-readable medium on which is stored a set of instructions (i.e., software) embodying any one, or all, of the methodologies described herein.

According to the present invention, it is possible to recognize and search for a word or words detected from a user's natural utterance with a relatively small memory capacity and less computing power.

In addition, a speech recognition apparatus according to the present invention is applied to telematics technology, enabling recognition and search of a word or words detected from a user's natural utterance with a small memory capacity and less computing power.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A speech recognition method in which a word is recognized from a user's natural utterance, the speech recognition method comprising:
capturing speech as a speech signal and extracting features from the speech signal;
selecting candidates of a subword among subwords of the word based on the extracted features and displaying the candidate subwords for the subword;
selecting candidates of a next subword following the subword based on the selected candidates of the subword and displaying the candidates of the next subword; and
determining whether the user has selected one of the candidates of the next subword and, if not, selecting candidates of subwords following the next subword based on the series of subwords that have been previously selected by the user and displaying the selected candidates of the next subword.

2. The speech recognition method of claim 1, wherein the subwords comprise syllables of the word.

3. The speech recognition method of claim 1, further comprising displaying words containing the subwords or series of subwords that have been previously selected by the user.

4. The speech recognition method of claim 1, further comprising, if the user selects one of the candidates, storing the selected candidate words in a user profile database.

5. The speech recognition method of claim 1, wherein the selecting of one of the candidate subwords comprises selecting using a touch pen or a keypad.

6. The speech recognition method of claim 1, further comprising performing a speaker adaptation operation on an acoustic model after the user selects the candidate word.

7. A speech recognition apparatus that recognizes a word from a user's natural utterance, the speech recognition apparatus comprising:
a microphone to convert the user's speech into an electrical signal;
a feature extraction module to extract features from the electrical speech signal;
a subword decoder to divide the word into a plurality of subwords based on the extracted features and select subword candidates for each of the subwords of the word;
a display module to display the subword candidates for each of the subwords of the word;
an input module to allow the user to select one of the subword candidates for each of the subwords of the word; and
a determination module to determine one of candidate words that matches the word based on a subword candidate or a series of subword candidates that have been selected by the user using the input module.

8. The speech recognition apparatus of claim 7, wherein the subwords comprise syllables of the word.

9. The speech recognition apparatus of claim 7, wherein the display module comprises a recognition result window on which subword candidates for a subword currently being searched for are displayed and a searched candidate subword window on which words matched to the subword series having been recognized are displayed.

10. The speech recognition apparatus of claim 7, further comprising a letter input module used to allow the user to enter a subword or a series of subwords.

11. The speech recognition apparatus of claim 7, further comprising a user profile database to store a selected word.

12. The speech recognition apparatus of claim 7, wherein the input module includes at least one of a touch pen, a key screen, and a keypad.

13. The speech recognition apparatus of claim 7, further comprising a speaker adaptation module to perform a speaker adaptation operation on an acoustic model.

14. A navigation system comprising:
a display device;
a speech recognition apparatus to capture speech as a speech signal from a user's natural utterance, extract features from the speech signal, divide a word or word series corresponding to the speech signal into a plurality of subwords, select subword candidates for each of the subwords of the word, and recognize the name of a place designated by the word based on a subword or subword series selected by the user among the subword candidates;
a map database to store maps of different places; and
a navigation controller to fetch a map corresponding to the recognized place name received from the speech recognition apparatus from the map database and transmit the fetched map to the display device.

15. The navigation system of claim 14, wherein the speech recognition apparatus comprises:
a microphone to convert the user's speech into an electrical signal;
a feature extraction module to extract features from the electrical speech signal;
a subword decoder to divide the place name into a plurality of subwords based on the extracted features and select subword candidates for each of the subwords of the place name;
a display module to display the subword candidates for each of the subwords of the place name;
an input module to allow the user to select one of the subword candidates; and
a determination module to determine a place name based on the subword candidates selected using the input module.

16. The navigation system of claim 15, wherein the subwords comprise syllables of the place name.

17. A storage for controlling a computer according to a speech recognition method in which a word is recognized from a user's natural utterance, the speech recognition method comprising:
capturing a speech as a speech signal and extracting features from the speech signal;
selecting candidates of a subword among subwords of the word based on the extracted features and displaying the candidate subwords for the subword;
selecting candidates of a next subword following the subword based on the selected candidates of the subword and displaying the candidates of the next subword; and
determining whether the user has selected one of the candidates of the next subword and, if not, selecting candidates of subwords following the next subword based on the series of subwords that have been previously selected by the user and displaying the selected candidates of the next subword.

18. The storage of claim 17, wherein the subwords comprise syllables of the word.

19. The storage of claim 17, further comprising displaying words containing the subwords or series of subwords that have been previously selected by the user.

20. The storage of claim 17, further comprising, if the user selects one of the candidates, storing the selected candidate words in a user profile database.

21. The storage of claim 17, wherein the selecting of one of the candidate subwords comprises selecting using a touch pen or a keypad.

22. The storage of claim 17, further comprising performing a speaker adaptation operation on an acoustic model after the user selects the candidate word.
